(19) United States
(12) Patent Application Publication
(10) Pub. No.: US 2025/0141626 A1
(43) Pub. Date: May 1, 2025

(54) USER EQUIPMENT AND METHOD EXECUTED BY USER EQUIPMENT

(71) Applicant: Samsung Electronics Co., Ltd., Gyeonggi-do (KR)

(72) Inventors: Pengru LI, Beijing (CN); Qi XIONG, Beijing (CN); Feifei SUN, Beijing (CN)

(21) Appl. No.: 18/834,830

(22) PCT Filed: Mar. 23, 2023
(86) PCT No.: PCT/KR2023/003839

§ 371 Date: Jul. 31, 2024

(30) Foreign Application Priority Data
Apr. 2, 2022 (CN) 202210351009.1
Jun. 15, 2022 (CN) 202210681881.2

(51) Int. Cl. H04L 5/00

(52) U.S. Cl. CPC H04L 5/0051; H04L 5/0064

(57) ABSTRACT

The present disclosure provides a user equipment and a method executed by the user equipment. A method executed by a user equipment UE, includes: determining whether a reference signal for positioning collides with other downlink signals and/or channels, and/or other uplink signals and/or channels; and determining a behaviour of the UE according to a result of the determination.

### TECHNICAL FIELD

The present disclosure generally relates to a field of communications, and more par-ticularly, to behaviours of a UE when a reference signal for positioning collides and/or does not collide with other signals/channels.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Behaviours of a UE when a reference signal for positioning collides and/or does not collide with other signals/channels are required.

### Solution to Problem

According to one aspect of the present disclosure, there is provided a method executed by a user equipment UE in a communication system. The method may include: determining whether a reference signal for positioning collides with other downlink signals and/or channels, and/or other uplink signals and/or channels; and determining a behaviour of the UE according to a result of the determination.

According to some implementations, in the method, if a time interval from a time unit and/or frequency unit for completing decoding of scheduling indication information for the other downlink signals and/or channels, or receiving the scheduling indication information of the other downlink signals and/or channels, to a starting position of the reference signal for positioning, and/or a starting position of a positioning reference signal processing window PPW, and/or a starting position of a discontinuous reception DRX cycle is less than or not greater than a first threshold value, then the UE may determine that the reference signal for positioning collides with other downlink signals and/or channels and/or other uplink signals and/or channels; and/or if a time interval from a time unit and/or frequency unit for determining resources for transmitting the other uplink signals and/or channels or preparing for transmission of the other uplink signals and/or channels, to the starting position of the reference signal for positioning, and/or the starting position of the positioning reference signal processing window PPW, and/or the starting position of the discontinuous reception DRX cycle is less than or not greater than a second threshold value, then the UE may determine that the reference signal for positioning collides with other downlink signals and/or channels and/or or other uplink signals and/or channels; and/or if UE determines the expected reception of the other downlink signals and/or channels and/or the resources for the expected other uplink signals and/or channels or the expected transmission of the other uplink signals and/or channels in the PPW and/or DRX cycle later than X time units before the starting position of the reference signal for positioning and/or the starting position of the PPW and/or the starting position of the DRX cycle, then the UE may determine that the reference signal for positioning collides with other downlink signals and/or channels and/or other uplink signals and/or channels; and/or if a time interval from a time unit and/or frequency unit that the UE determines to transmit the resources of other uplink signals and/or channels or prepare for transmission of other uplink signals and/or channels in the PPW and/or DRX cycle, to the starting position of the reference signal for positioning, and/or the starting position of the PPW, and/or the starting position of the DRX cycle is less than or not greater than a third threshold value, then the UE may determine that the reference signal for positioning collides with other downlink signals and/or channels and/or other uplink signals and/or channels; and/or if a time interval from a time unit and/or frequency unit that the UE determines to receive other downlink signals and/or channels within the PPW and/or DRX cycle, to the starting position of the reference signal for positioning, and/or the starting position of the PPW, and/or the starting position of the DRX cycle is less than or not greater than a fourth threshold value, the UE may determine that the reference signal for positioning collides with the other downlink signals and/or channels and/or other uplink signals and/or channels.

According to some implementations, in the method, if a time interval from a time unit and/or frequency unit for completing decoding of the scheduling indication information for the other downlink signals and/or channels, or receiving the scheduling indication information of the other downlink signals and/or channels, to a starting position of the reference signal for positioning, and/or a starting position of a positioning reference signal processing window PPW, and/or a starting position of a discontinuous reception DRX cycle is greater than or not less than a first threshold value, then the UE may determine that the reference signal for positioning does not collide with other downlink signals and/or channels and/or other uplink signals and/or channels; and/or if a time interval from a time unit and/or frequency unit for determining resources for transmitting the other uplink signals and/or channels or preparing for transmission of the other uplink signals and/or channels, to the starting position of the reference signal for positioning, and/or the starting position of the positioning reference signal processing window PPW and/or the starting position of the discontinuous reception DRX cycle is greater than or not less than a second threshold value, then the UE may determine that the reference signal for positioning does not collide with other downlink signals and/or channels and/or or other uplink signals and/or channels; and/or if UE determines the expected reception of the other downlink signals and/or channels and/or the resources for the expected other uplink signals and/or channels or the expected transmission of other uplink signals and/or channels in the PPW and/or DRX cycle no later than X time units before the starting position of the reference signal for positioning and/or the starting position of the PPW and/or the starting position of the DRX cycle, then the UE may determine that the reference signal for positioning does not collide with other downlink signals and/or channels and/or other uplink signals and/or channels; and/or if a time interval from a time unit and/or frequency unit that the UE determines to transmit resources of other uplink signals and/or channels or prepare for transmission of other uplink signals and/or channels within the PPW and/or DRX cycle, to the starting position of the reference signal for positioning, and/or the starting position of the PPW, and/or the starting position of the DRX cycle is greater than or not less than a third threshold value, then the UE may determine that the reference signal for positioning does not collide with other downlink signals and/or channels and/or other uplink signals and/or channels; and/or if a time interval from a time unit and/or frequency unit that the UE determines to receive other downlink signals and/or channels within the PPW and/or DRX cycle, to the starting position of the reference signal for positioning, and/or the starting position of the PPW, and/or the starting position of the DRX cycle is greater than or not less than a fourth threshold value, the UE may determine that the reference signal for positioning does not collide with other downlink signals and/or channels and/or other uplink signals and/or channels.

According to some implementations, in the method, the determining a behaviour of the UE may include: determining the behaviour of the UE, according to priorities of the reference signal for positioning and other downlink signals and/or channels and/or other uplink signals and/or channels.

According to some implementations, in the method, if the reference signal for positioning is determined to be of a high priority, and/or if the UE is expected to receive the reference signal for positioning, the behaviour of the UE may include a combination of one or more of items below: if the reference signal for positioning does not collide with other downlink signals and/or channels and/or other uplink signals and/or channels, the UE is expected to prioritize the reception of the reference signal for positioning within the PPW and/or DRX cycle; and/or if the reference signal for positioning does not collide with other downlink signals and/or channels and/or other uplink signals and/or channels, the UE, according to a UE capability, receives other downlink signals and/or channels and/or transmits other uplink signals and/or channels; and/or if the reference signal for positioning collides with other downlink signals and/or channels and/or other uplink signals and/or channels, the UE is expected to receive the reference signal for positioning, and/or the UE is expected not to receive or cancel reception of or drop the other downlink signals and/or channels; and/or if the reference signal for positioning collides with other downlink signals and/or channels and/or other uplink signals and/or channels, the UE does not transmit or cancel transmission of the other uplink signals and/or channels.

According to some implementations, in the method, if the reference signal for positioning is determined to be of a low priority, and/or if the UE is expected to receive other downlink signals and/or channels and/or transmit other uplink signals and/or channels, the behaviour of the UE may include a combination of one or more of items below: if the reference signal for positioning does not collide with other downlink signals and/or channels and/or other uplink signals and/or channels, the UE is expected to receive other downlink signals and/or channels, and/or transmit other uplink signals and/or channels, and/or UE does not expect to receive the reference signal for positioning; if the reference signal for positioning collides with other downlink signals and/or channels and/or other uplink signals and/or channels, the UE is expected to receive other downlink signals and/or channels and/or transmit other uplink signals and/or channels, and/or the UE is expected to receive the reference signal for positioning according to a UE capability.

According to some implementations, in the method, the determining the behaviour of the UE may include: if the reference signal for positioning collides with high priority uplink signals and/or channels or random access procedure related uplink signals and/or channels or random access procedure related downlink signals and/or channels, determining that the UE transmits high priority uplink signals and/or channels or random access procedure related uplink signals and/or channels or receives random access procedure related downlink signals and/or channels, and the UE is not expected to receive the reference signal for positioning; and/or if the reference signal for positioning collides with a hybrid automatic repeat request HARQ acknowledgement ACK and/or negative acknowledgement NACK, determining that the UE is expected to receive and/or transmit HARQ ACK and/or NACK, and the UE does not receive the reference signal for positioning; and/or if the reference signal for positioning does not collide with a synchronization signal block SSB, deciding, by the UE, according to whether the UE supports parallel processing of the reference signal for positioning and radio resource management RRM measurement, to receive the reference signal for positioning and/or the SSB; or if the reference signal for positioning collides with the SSB and the UE supports parallel processing of the reference signal for positioning and RRM measurement, deciding, by the UE, to receive the reference signal for positioning and/or the SSB; or if the UE does not support parallel processing of the reference signal for positioning and RRM measurement, determining, according to priority states of the reference signal for positioning and other downlink signals and/or channels which are non-SSB, that the UE is expected to receive reference signal for positioning or the SSB.

According to some implementations, the method may further include determining a carrier-specific scaling factor CSSF according to modes below: if the reference signal for positioning is determined to be of a high priority, then CSSF=1; and/or if the reference signal for positioning is determined to be of a low priority and/or the UE determines to receive the SSB, then calculating the CSSF according to a calculation mode of a Stand Alone operation mode (SA mode) and/or NR-NR Dual Connectivity mode (NR-DC mode) and/or NR Evolved universal terrestrial radio access Dual Connectivity mode (NE-DC mode).

According to some implementations, in the method, the other downlink signals and/or channels may include a combination of one or more of items below: a physical downlink control channel PDCCH, a physical downlink shared channel PDSCH, a synchronization signal block SSB, a channel state information reference signal CSI-RS; a physical downlink control channel PDCCH and/or a physical downlink shared channel PDSCH for scheduling and/or transmitting a system information block SIB, a PDCCH and/or PDSCH for scheduling and/or transmitting control resource set 0 CORESET0; a specific PDCCH and/or PDSCH, and/or repeated transmissions of a PDCCH and/or PDSCH; a PDSCH scheduled by a media access control element MAC CE; a PDCCH and/or PDSCH for scheduling and/or transmitting a downlink small data transmission DL SDT signal; paging downlink control information in an idle state and/or inactive state, a paging PDSCH and/or a paging PDCCH.

According to some implementations, in the method, the other uplink signals and/or channels may include a combination of one or more of items below: a physical uplink control channel PUCCH and/or a physical uplink shared channel PUSCH, and/or repeated transmissions of a PUCCH and/or PUSCH; a PUCCH for message 4 and/or message B in a random access procedure, a physical uplink shared channel PUSCH and/or repeated transmissions of PUSCH for message 3 and/or message A; a physical random access channel PRACH, a valid random access occasion in the random access procedure; a sounding reference signal SRS.

According to some implementations, in the method, the starting position of the reference signal for positioning may be a starting position of a first reference signal for positioning and/or a starting position of any reference signal for positioning within the PPW; and/or the first threshold value and/or the second threshold value and/or the third threshold value and/or the fourth threshold value may be a parameter value reported by the UE according to its own processing capability and/or a parameter value configured by a base station and/or a preconfigured parameter value; and/or the X may be a parameter value reported by the UE according to its own processing capability and/or a parameter value configured by a base station and/or a preconfigured parameter value.

According to some implementations, the method may further include determining priorities of the reference signal for positioning and other uplink signals and/or channels according to a combination of one or more of items below: priority options and/or states of the reference signal for positioning and other downlink signals and/or channels; indication from a base station and/or a sidelink device to prioritize the reception of the reference signal for positioning, or to prioritize the transmission of resources of the other uplink signals and/or channels or to prioritize the transmission of other uplink signals and/or channels; a default priority relationship; and a default UE behaviour.

According to some implementations, in the method, the default priority relationship may include a combination of one or more of items below: a priority of the reference signal for positioning being higher than priorities of all and/or some other uplink signals and/or channels; the priority of the reference signal for positioning being equal to priorities of all and/or some other uplink signals and/or channels; and the priority of the reference signal for positioning being lower than priorities of all and/or some other uplink signals and/or channels.

According to some implementations, in the method, the determining a behaviour of the UE may include: if the positioning reference signal processing window PPW is activated and/or the priority of the reference signal for positioning is higher than priorities of other downlink signals and/or channels and/or other uplink signals and/or channels, and with respect to impacted symbols within the PPW, a behaviour of a MAC entity is: if ra-ResponseWindow or a-ContentionResolutionTimer or msgB-Response Window is running, then receiving other downlink signals and/or channels and/or transmitting other uplink signals and/or channels; or if the PPW is activated and/or the priority of the reference signal for positioning is lower than the priorities of other downlink signals and/or channels and/or other uplink signals and/or channels, with respect to the impacted symbols within the PPW, behaviours of the MAC entity may include a combination of one or more of items below: if a reception notification of the reference signal for positioning is received, not receiving other downlink signals and/or channels and/or not transmitting other uplink signals and/or channels; if a reception notification of the reference signal for positioning is not received, receiving other downlink signals and/or channels and/or transmitting other uplink signals and/or channels.

According to some implementations, in the method, the reception notification of the reference signal for positioning may be a signalling for indicating to receive the reference signal for positioning, and/or the reception notification of the reference signal for positioning may be transmitted from a lower layer of the UE to a higher layer of the UE.

According to another aspect of the present disclosure, there is provided a method executed by a user equipment UE. The method may include: determining that a priority of a reference signal for positioning is a low priority, and/or the UE is expected to receive other downlink signals and/or channels, and/or the UE is expected to transmit other uplink signals and/or channels, and determining that the reference signal for positioning collides with other downlink signals and/or channels and/or other uplink signals and/or channels; and considering the priority of the reference signal for positioning as a higher priority.

According to some implementations, in the method, it may be determined that the reference signal for positioning collides with other downlink signals and/or channels and/or other uplink signals and/or channels according to a combination of one or more of items below: a time interval from a time unit and/or frequency unit for completing decoding of the scheduling indication information for the other downlink signals and/or channels, or receiving the scheduling indication information of the other downlink signals and/or channels, to a starting position of the reference signal for positioning, and/or a starting position of a positioning reference signal processing window PPW, and/or a starting position of a discontinuous reception DRX cycle is less than or not greater than a first threshold value; and/or a time interval from a time unit and/or frequency unit for determining resources for transmitting the other uplink signals and/or channels or preparing for transmission of the other uplink signals and/or channels, to the starting position of the reference signal for positioning, and/or the starting position of the positioning reference signal processing window PPW and/or the starting position of the discontinuous reception DRX cycle is less than or not greater than a second threshold value; and/or UE determines the expected reception of the other downlink signals and/or channels and/or the resources for the expected other uplink signals and/or channels or the expected transmission of other uplink signals and/or channels in the PPW and/or DRX cycle later than X time units before the starting position of the reference signal for positioning and/or the starting position of the PPW and/or the starting position of the DRX cycle; and/or a time interval from a time unit and/or frequency unit that the UE determines to transmit the resources of other uplink signals and/or channels or prepare for transmission of other uplink signals and/or channels in the PPW and/or DRX cycle, to the starting position of the reference signal for positioning, and/or the starting position of the PPW, and/or the starting position of the DRX cycle is less than or not greater than a third threshold value; and/or a time interval from a time unit and/or frequency unit that the UE determines to receive other downlink signals and/or channels within the PPW and/or DRX cycle, to the starting position of the reference signal for positioning, and/or the starting position of the PPW, and/or the starting position of the DRX cycle is less than or not greater than a fourth threshold value.

According to some implementations, the method may further include: receiving the reference signal for positioning; and/or not receiving other downlink signals and/or channels; and/or not transmitting other uplink signals and/or channels.

According to some implementations, in the method, the other downlink signals and/or channels and/or other uplink signals and/or channels do not include: random access procedure related signals and/or channels; and/or a hybrid automatic repeat request HARQ acknowledgement ACK and/or negative acknowledgement NACK.

According to yet another aspect of the present disclosure, there is provided a user equipment. The user equipment may include: a transceiver; and a processor, coupled to the transceiver and configured to execute any one of the steps in the above-described method.

### Advantageous Effects of Invention

The disclosure relates to a 5G or 6G communication system for supporting a higher data transmission rate.

### BRIEF DESCRIPTION OF DRAWINGS

FIG. 1 shows an exemplary wireless network according to various embodiments of the present disclosure.

FIG. 2a shows exemplary wireless transmitting and receiving paths according to the present disclosure.

FIG. 2b shows exemplary wireless transmitting and receiving paths according to the present disclosure.

FIG. 3a shows an exemplary UE according to the present disclosure.

FIG. 3b shows an exemplary gNB according to the present disclosure.

FIG. 4 is a schematic diagram showing DL signal reception timeline within an activated first PPW according to an exemplary embodiment of the present disclosure.

### MODE FOR THE INVENTION

The following description with reference to the accompanying drawings is provided to facilitate comprehensive understanding of various embodiments of the present disclosure as defined by the claims and equivalents thereof. The description includes various specific details to facilitate understanding, but should be considered exemplary only. Therefore, those ordinarily skilled in the art will recognize that, various changes and modifications may be made to the various embodiments described herein without departing from the scope and spirit of the present disclosure. In addition, for clarity and conciseness, description of well-known functions and structures may be omitted.

The terms and wordings used in the following description and claims are not limited to their dictionary meaning, but are merely used by an inventor to enable a clear and consistent understanding of the present disclosure. Therefore, it should be apparent to those skilled in the art that, the following description of various embodiments of the present disclosure is provided for illustration purposes only and not for the purpose of limiting the scope of the present disclosure as defined by the appended claims and equivalents thereof.

It should be understood that, the singular forms of “a”, “an” and “the” include plural references unless the context clearly dictates otherwise. Thus, for example, a reference to a “component surface” includes a reference to one or more such surfaces.

The terms “include” or “may include” refer to presence of a correspondingly disclosed function, operation, or component that may be used in various embodiments of the present disclosure, rather than limiting presence of one or more additional functions, operations, or features. Furthermore, the terms “comprise” or “have” may be construed to indicate certain characteristics, numbers, steps, operations, constituent elements, components, or combinations thereof, but should not be construed as excluding possibility of presence of one or more other characteristics, numbers, steps, operations, constituent elements, components, or combinations thereof.

The term “or” as used in various embodiments of the present disclosure includes any of the listed terms and all combinations thereof. For example, “A or B” may include A, may include B, or may include both A and B. The term “and/or” as used in various embodiments of the present disclosure includes any of the listed terms and all combinations thereof. For example, “A and/or B” may include A, may include B, or may include both A and B. For clarity, “/” is used in various embodiments of the present disclosure to represent an “and/or” relationship.

It should be understood by those skilled in the art that, the term “interval” described in conjunction with various embodiments of the present disclosure may include a time interval, and may also include a frequency interval.

Unless defined differently, all terms (including technical or scientific terms) used in the present disclosure have the same meaning as understood by those ordinarily skilled in the art according to the present disclosure. Common terms as defined in dictionaries are to be construed to have meanings consistent with the context in the relevant technical field, and should not be construed ideally or overly formalized unless ex-plicitly so defined in the present disclosure.

The technical solutions of the embodiments of the present application may be applied to various communication systems, for example: Global System for Mobile communications (GSM) system, Code Division Multiple Access (CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD), Universal Mobile Telecommunication System (UMTS), Worldwide interoperability for Microwave Access (WiMAX) communication system, 5th generation (5G) system or New Radio (NR), etc. In addition, the technical solutions of the embodiments of the present application may be applied to future-oriented communication technologies.

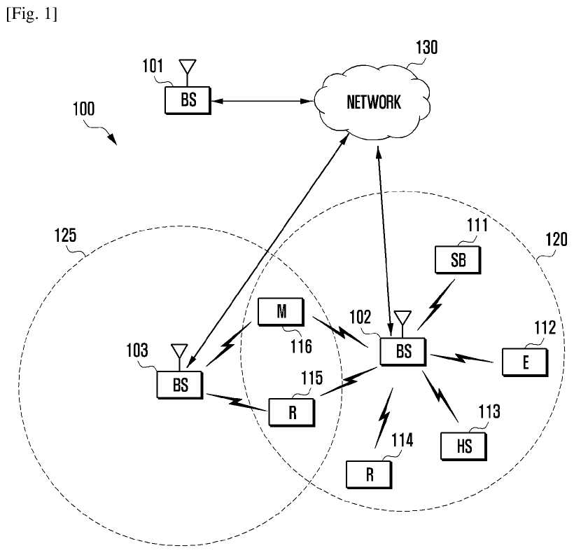

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network in-frastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

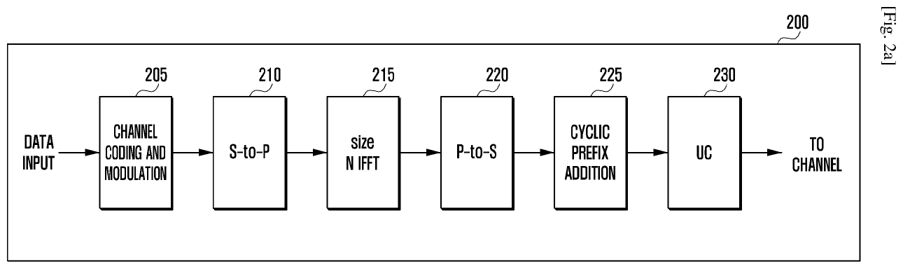

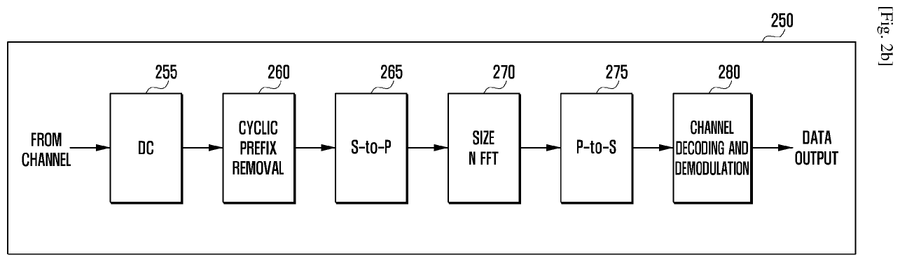

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

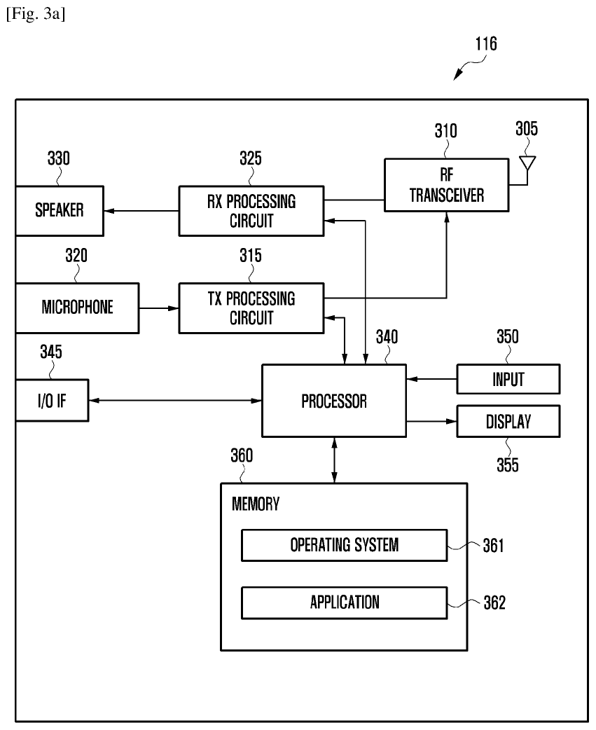

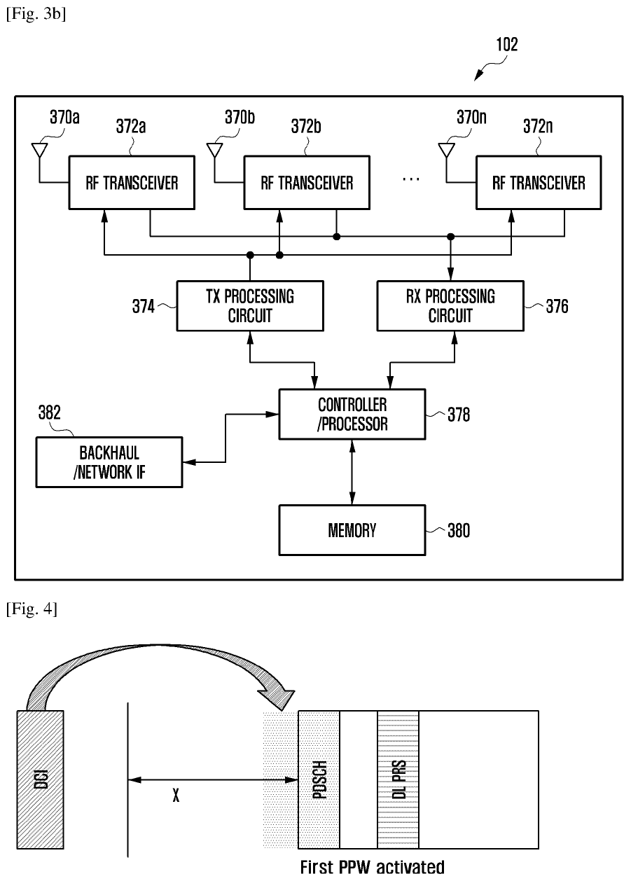

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these ac-cessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also referred to as a time unit) in the present application may be: one OFDM symbol, one OFDM symbol group (composed of a plurality of OFDM symbols), one slot, one slot group (composed of a plurality of slots), one subframe, one subframe group (composed of a plurality of subframes), one system frame, one system frame group (composed of a plurality of system frames), etc.; the time domain unit may also be an absolute time unit, for example, 1 millisecond, 1 second, etc.; and the time domain unit may also be a combination of various granularities, for example, n1 slots plus n2 OFDM symbols, where, n1 and n2 may be natural numbers.

A frequency domain unit (also referred to as a frequency unit) in the present application may be: one subcarrier, one subcarrier group (composed of a plurality of subcarriers), one Resource Block (RB), which may also be referred to as a Physical Resource Block (PRB), one resource block group (composed of a plurality of RBs), one bandwidth part (BWP), one bandwidth part group (composed of a plurality of BWPs)), one frequency band/carrier, one frequency band group/carrier group, etc.; the frequency domain unit may also be an absolute frequency unit, for example, 1 Hz, 1 kHz, etc.; and the frequency domain unit may also be a combination of various granularities, for example, M1 PRBs plus M2 subcarriers, where, M1 and M2 may be natural numbers.

Exemplary embodiments of the present disclosure are further described below in conjunction with the accompanying drawings.

The text and drawings are provided by way of examples only to assist the reader in understanding the present disclosure. They are not intended and should not be construed to limit the scope of the present disclosure in any way. Although certain embodiments and examples have been provided, it will be apparent to those skilled in the art based on the disclosure herein that the shown embodiments and examples may be modified without departing from the scope of the present disclosure.

A transmission link in the wireless communication system mainly includes: a downlink communication link from the 5G New Radio (NR) gNB to the User Equipment (UE), and an uplink communication link from the UE to the network.

A node for positioning measurement in the wireless communication system (e.g., a current wireless communication system) may include: a UE for initiating a positioning request message, a Location Management Function (LMF) for issuance of positioning assistance data and UE positioning, a gNB or a Transmission-Reception Point (TRP) for broadcasting positioning assistance data and for uplink positioning measurement, and a UE for downlink positioning measurement.

According to a UE capability and/or an indication from the base station, a reference signal for positioning has different priorities from other downlink signals/channels and/or other uplink signals/channels. For example, a user equipment located in a Radio Resource Control Connected mode/state may use a Measurement Gap (MG) and/or a Positioning reference signal Processing Window (PPW) to execute measurement of the reference signal for positioning. When using a PPW for Downlink Positioning Reference Signal (DL PRS) measurement, for receiving the DL PRS outside the measurement gap and within the DL PRS processing window, if the UE determines the DL PRS priority is higher than other DL signals or channels (e.g., except Synchronization Signal Block (SSB)) as indicated by the base station or as implied by UE capability, the UE is expected to measure the DL PRS; otherwise, the UE is not expected to measure the DL PRS and expected to receive other DL signals/channels, subject to UE capabilities. In addition, for example, in the current wireless communication system, a user equipment in the Radio Resource Control Inactive mode/state may execute measurement of DL PRS in a Discontinuous Reception (DRX cycle). The UE in the RRC inactive mode/state is expected to prioritize the reception of any other downlink signals/channels than the reception of DL PRS. After the priorities of the reference signal for positioning and other downlink signals/channels and/or other uplink signals/channels are determined, how to determine when the reference signal for positioning collides and/or does not collide with other downlink signals/channels and/or other uplink signals/channels, and which receive operation or transmit operation the UE executes (i.e. the behaviours of the UE) when the reference signal for positioning collides and/or does not collide with other downlink signals/channels and/or other uplink signals/channels through a scheduling indication is a problem to be solved. Specifically, in the present disclosure, a method and a device for receiving or transmitting a signal will be introduced. In an embodiment of the present disclosure, methods of two aspects below will be introduced: determining conditions that the reference signal for positioning collides and/or does not collide with other downlink signals/channels and/or other uplink signals/channels, and determining the behaviours of the UE under conditions that collision occurs and/or does not occur. In this embodiment, for convenience of description, the methods are exemplified by using the DL PRS as a non-limiting example of the reference signal for positioning, and those skilled in the art should understand that, the methods described may also be used for measurement of other signals without depart from the scope of the present disclosure.

Optionally, the application scenario of the signal receiving or transmitting method may include a combination of one or more of items below:
It is not limited to a specific application scenario;
When using a time window and/or a time interval and/or a duration for measurement of DL PRS;
When the network uses time division duplex TDD and/or frequency division duplex FDD data transmission modes, wherein, a data transmission mode of Half Duplex-Frequency Division Duplex (HD-FDD) (e.g., used in a low-capability device) and a data transmission mode of time division duplex use a same condition that collision occurs and/or does not occur and execute a same UE behaviour;
The time window and/or the time interval and/or the duration may be a positioning reference signal processing window PPW and/or a DRX cycle.

After the UE receives scheduling indication information of other downlink signals/channels, for example, after the UE receives downlink control information DCI and/or a downlink media access control MAC control element CE for scheduling other downlink signals/channels, the UE will decode the scheduling indication information to acquire location of a time unit where other downlink signals/channels are expected (needed) to be received. The condition for determining that the reference signal for positioning collides and/or does not collide with the other downlink signals/channels and/or other uplink signals/channels may include a combination of one or more of items below:
When a time interval from a time unit and/or frequency unit for completing decoding of the scheduling indication information for the other downlink signals/channels, or receiving the scheduling indication information of the other downlink signals/channels, to a starting position of the reference signal for positioning (e.g., the next closest one), and/or a starting position of a PPW, and/or a starting position of a DRX cycle is less than or not greater than a first threshold value N1; and/or when a time interval from a time unit and/or frequency unit of determining resources for transmitting the other uplink signals/channels or preparing for transmission of the other uplink signals/channels, to the starting position of the reference signal for positioning (e.g., the next closest one), and/or the starting position of the PPW and/or the starting position of the DRX cycle is less than or not greater than a second threshold value N2, the UE considers that the reference signal for positioning collides with the other downlink signals/channels and/or the other uplink signals/channels;
If UE determines the expected reception of other DL signals and channels or DCI/MAC CE scheduled/activated other DL signals/channels and/or the resource for the expected other UL signals/channels or the expected transmission of other UL signals/channels in the PPW and/or DRX cycle later than the X time units before the starting position of the DL PRS and/or the starting position of the PPW and/or the starting position of the DRX cycle,, it is considered that the reference signal for positioning collides with the other downlink signals/channels and/or the other uplink signals/channels; where, X may be a natural number;
When a time interval from a time unit and/or frequency unit that the UE determines to transmit resources of other uplink signals/channels or prepare for transmission of other uplink signals/channels in the PPW and/or DRX cycle, to the starting position of the reference signal for positioning and/or the starting position of the PPW and/or the starting position of the DRX cycle is less than or not greater than a third threshold value N3, the UE considers that the reference signal for positioning collides with the other uplink signals/channels;
When a time interval from a time unit and/or frequency unit that the UE determines to receive other downlink signals/channels within the PPW and/or DRX cycle, to the starting position of the reference signal for positioning and/or the starting position of the PPW and/or the starting position of the DRX cycle is less than or not greater than a fourth threshold value N4, the UE considers that the reference signal for positioning collides with the other downlink signals/channels;
When a time interval from a time unit and/or frequency unit for completing decoding of the scheduling indication information for the other downlink signals/channels, or receiving the scheduling indication information of the other downlink signals/channels, to the starting position of the reference signal for positioning (the next closest one) and/or the starting position of the PPW and/or the starting position of the DRX cycle is greater than or not less than the first threshold value N1; and/or when a time interval from a time unit and/or frequency unit of determining resources for transmitting the other uplink signals/channels or preparing for transmission of the other uplink signals/channels, to the starting position of the reference signal for positioning (the next closest one) and/or the starting position of the PPW and/or the starting position of the DRX cycle is greater than or not less than the second threshold value N2, the UE considers that the reference signal for positioning does not collide with the other downlink signals/channels and/or the other uplink signals/channels;
If UE determines the expected reception of other DL signals and channels or DCI/MAC CE scheduled/activated other DL signals/channels and/or the resource for the expected other UL signals/channels or the expected transmission of other UL signals/channels in the PPW and/or DRX cycle no later than the X time units before the starting position of the DL PRS and/or the starting position of the PPW and/or the starting position of the DRX cycle, it is considered that the reference signal for positioning does not collide with the other downlink signals/channels and/or the other uplink signals/channels;
When a time interval from a time unit and/or frequency unit that the UE determines to transmit resources of other uplink signals/channels or prepare for transmission of other uplink signals/channels in the PPW and/or DRX cycle, to the starting position of the reference signal for positioning and/or the starting position of the PPW and/or the starting position of the DRX cycle is greater than or not less than the third threshold value N3, the UE considers that the reference signal for positioning does not collide with the other uplink signals/channels;
When a time interval from a time unit and/or frequency unit that the UE determines to receive other downlink signals/channels within the PPW and/or DRX cycle, to the starting position of the reference signal for positioning and/or the starting position of the PPW and/or the starting position of the DRX cycle is greater than or not less than the fourth threshold value N4, the UE considers that the reference signal for positioning does not collide with the other downlink signals/channels.
The occurrence of collision may include a combination of one or more of items below:
   On a same time unit and/or frequency unit, the transmitted reference signal for positioning completely and/or partially overlaps with the other downlink signals/channels and/or the other uplink signals/channels;
   On time unit and/or frequency unit, the transmitted reference signal for positioning with a time interval N5 completely and/or partially overlaps with the other downlink signals/channels and/or the other uplink signals/channels. The time interval N5 may be a time interval from an end position of the reference signal for positioning to the starting position of the other downlink signals/channels and/or the other uplink signals/channels (the next closest one), and/or a time interval from an end position of the other downlink signals/channels and/or the other uplink signals/channels to the starting position of the reference signal for positioning (the next closest one). Wherein, the time interval N5 may be a real number greater than or equal to 0, and may include time intervals such as switching time and/or processing time, etc. When the reference signal for positioning and the other downlink signals/channels and/or the other uplink signals/channels have a same parameter set, the time interval N5 is equal to 0. Optionally, N5 is a value less than the first threshold value N1.
The other downlink signals/channels may include a combination of one or more of items below:
   A physical downlink control channel PDCCH, a physical downlink shared channel PDSCH, a synchronization signal block SSB (including but not limited to a cell defined-SSB (CD-SSB), non-cell-defined SSB (NCD-SSB), etc.), a channel state information reference signal CSI-RS, etc.;
   A physical downlink control channel PDCCH and/or a physical downlink shared channel PDSCH scheduling and/or transmitting a system information block SIB, and a PDCCH and/or a PDSCH scheduling and/or transmitting control resource set 0 CORESET0;
   A specific PDCCH/PDSCH (and/or repeated transmissions of PDCCH/PDSCH), for example, a message 2 (msg2) and/or message B (msgB) in the random access procedure (RA procedure), a PDCCH/PDSCH (and/or repeated transmissions of PDCCH/PDSCH) of message 2 (msg2) and/or message B (msgB), a High Priority (HP) or Low Priority (LP) PDSCH (and/or repeated transmissions of PDSCH), a search space of PDCCH and/or PDSCH (and/or repeated transmissions of PDCCH/PDSCH) of control resource set 0 CORESET0 of message 3 (msg3), a search space of downlink physical downlink control channel (DL PDCCH) (and/or repeated transmissions of DL PDCCH) of message 4 (msg4); in some implementations, these specific PDCCHs/PDSCHs may also be referred to as random access procedure related PDCCHs/PDSCHs in the present application;
   A PDSCH scheduled by MAC CE;
   A PDCCH and/or PDSCH for scheduling and/or transmitting a downlink small data transmission DL SDT signal;
   Paging downlink control information (paging DCI), a paging PDSCH and/or a paging PDCCH in an idle state and/or inactive state (idle/inactive state).
The other uplink signals/channels may include a combination of one or more of items below:
   A High priority (HP) or Low priority (LP) Physical uplink control channel PUCCH/physical uplink shared channel PUSCH (and/or repeated transmissions of PUCCH/PUSCH);
   A PUCCH for message 4 (msg4) and/or message B (msgB) in a random access procedure, a physical uplink shared channel PUSCH (and/or repeated transmissions of PUSCH) for message 3 (msg3) and/or message A (msgA);
   A physical random access channel PRACH, a valid random access occasion (valid RO) in the random access procedure (RA procedure);
   A sounding reference signal SRS.
Optionally, the starting position of the DL PRS may be a starting position of a first DL PRS and/or a starting position of any DL PRS within the PPW;
Optionally, the PPW may be an activated PPW and/or a first PPW activated after applying an activation indication;
The first threshold value N1 and/or the second threshold value N2 and/or the third threshold value N3 and/or the fourth threshold value N4 may be a parameter value reported by the user equipment UE according to its own processing capability and/or a parameter value configured by a base station that is received by the UE and/or a pre-configured parameter value;
The X may be a parameter value reported by the user equipment UE according to its own processing capability and/or a parameter value configured by a base station that is received by the UE and/or a preconfigured parameter value. Optionally, X may be a value greater than or equal to (or not less than) the first threshold value N1;
The transmitting resources of other uplink signals/channels may include transmitting other uplink signals/channels on the time unit and/or frequency unit where the other uplink signals/channels are located; and the preparing for transmission of other uplink signals/channels may include transmitting the other uplink signals/channels by using a timing advance method.

The method for determining the priorities of the DL PRS and other uplink signals/channels and determining the behaviour of the UE when the DL PRS collides with other uplink signals/channels may include a combination of one or more of items below:
Determining the priorities of the DL PRS and other uplink signals/channels according to the priority options and/or states of the DL PRS and other downlink signals/channels. For example, when the UE reports that priority option 1 is supported, if the base station and/or the sidelink device indicates that the priority state of the DL PRS and other downlink signals/channels is 1, that is, the priority of the DL PRS is higher than the priorities of other downlink signals/channels, at this time, the priority of the DL PRS is also higher than the priorities of other uplink signals/channels; if the base station and/or the sidelink device indicates that the priority state of the DL PRS and other downlink signals/channels is 2, that is, the priority of the DL PRS is lower than the priorities of other downlink signals/channels, at this time, the priority of DL PRS is also lower than the priorities of other uplink signals/channels;
According to the indication from the base station and/or the sidelink device to prioritize the reception of DL PRS or prioritize the transmission of the resources of the other uplink signals/channels or transmission of other uplink signals/channels, optionally, the indication from the base station and/or the sidelink device may be a RRC signalling, and through the indication, the UE determines to receive the DL PRS or to transmit resources of the other uplink signals/channels or to transmit other uplink signals/channels. The method has higher flexibility.
Determining the priorities of DL PRS and other uplink signals/channels according to a default priority relationship. For example, the default priority relationship between the DL PRS and other uplink signals/channels may include a combination of one or more of items below:
   The priority of the DL PRS is higher than priorities of all and/or some other uplink signals/channels. In this case, latency for measuring the DL PRS may be reduced by prioritize the reception of the DL PRS, so as to implement low-latency positioning;
   The priority of DL PRS is equal to priorities of all and/or some other uplink signals/channels. At this time, the UE may receive the DL PRS and transmit other uplink signals/channels at a same time, and/or the UE may independently determine to receive the DL PRS or transmit one or some or all of the other uplink signals/channels. In this case, the latency for measuring the DL PRS may be reduced on the basis of less impact on transmission of some or all other more important other uplink signals/channels (e.g., RACH related signals), which guarantees integrity of the uplink data transmission process while implementing low-latency positioning;
   The priority of DL PRS is lower than priorities of all and/or some other uplink signals/channels. In this case, transmission of some and/or all other more important other uplink signals/channels (e.g., RACH-related signals) may be guaranteed prefer-entially, to avoid an impact of DL PRS measurement on normal uplink data transmission.
Determining, according to the default UE behaviour, to receive the DL PRS and/or transmit other uplink signals/channels, and/or determining that the UE may receive the DL PRS and/or transmit other uplink signals/channels according to a UE capability;
The transmitting resources of other uplink signals/channels may include transmitting other uplink signals/channels on the time unit and/or frequency unit where the other uplink signals/channels are located; and the preparing for transmission of other uplink signals/channels may include transmitting the other uplink signals/channels by using a timing advance method.

If the DL PRS is determined to be of a high priority and/or if the UE is expected to receive the DL PRS, for example, the DL PRS is determined to be of a high priority based on the UE capability and/or an indication from the base station, then the behaviours of the UE may include a combination of one or more of items below:
If a time interval from a time unit and/or frequency unit for completing decoding of the scheduling indication information for the other downlink signals/channels, or receiving the scheduling indication information of the other downlink signals/channels, to the starting position of the DL PRS and/or the starting position of the PPW and/or the starting position of the DRX cycle is greater than or not less than the first threshold value N1, and/or if a time interval from a time unit and/or frequency unit for determining resources for transmitting the other uplink signals/channels or preparing for transmission of the other uplink signals/channels, to the starting position of the DL PRS and/or the starting position of the PPW and/or the starting position of the DRX cycle is greater than or not less than the second threshold value N2, then the UE is expected to prioritize the reception of the DL PRS within the PPW and/or DRX cycle, and/or the UE may receive the other downlink signals/channels and/or transmit the other uplink signals/channels according to the UE capability; such operation may reduce reception latency of other downlink signals/channels and/or transmission latency of other uplink signals/channels without affecting reception of DL PRS, and increase spectral efficiency; if a time interval from a time unit and/or frequency unit for completing decoding of the scheduling indication information for the other downlink signals/channels, or receiving the scheduling indication information of the other downlink signals/channels, to the starting position of the DL PRS and/or the starting position of the PPW and/or the starting position of the DRX cycle is less than or not greater than the first threshold value N1, and/or if a time interval from a time unit and/or frequency unit for determining resources for transmitting the other uplink signals/channels or preparing for transmission of the other uplink signals/channels, to the starting position of the DL PRS, and/or the starting position of the PPW and/or the starting position of the DRX cycle is less than or not greater than the second threshold value N2, then the UE is expected to receive the DL PRS, not receive, or cancel reception of or drop the other downlink signals/channels, and/or does not transmit or cancels transmission of the other uplink signals/channels, so as to reduce interference of other downlink signals/channels and/or other uplink signals/channels on reception of DL PRS, and reduce latency of the positioning measurement process;
If UE determines the expected reception of other DL signals and channels or DCI/MAC CE scheduled/activated other DL signals/channels and/or the resource for the expected other UL signals/channels or the expected transmission of other UL signals/channels in the PPW and/or DRX cycle no later than the X time units before the starting position of the DL PRS and/or the starting position of the PPW and/or the starting position of the DRX cycle, then the UE is expected to prioritize the reception of the DL PRS within the PPW, and/or the UE may receive the other downlink signals/channels and/or transmit the other uplink signals/channels according to the UE capability, such operation may reduce reception latency of other downlink signals/channels and/or transmission latency of other uplink signals/channels without affecting reception of DL PRS, and increase spectral efficiency; If UE determines the expected reception of other DL signals and channels or DCI/MAC CE scheduled/activated other DL signals/channels and/or the resource for the expected other UL signals/channels or the expected transmission of other UL signals/channels in the PPW and/or DRX cycle later than the X time units before the starting position of the DL PRS and/or the starting position of the PPW and/or the starting position of the DRX cycle, then the UE is expected to receive the DL PRS, not receive or cancel reception of or drop the other downlink signals/channels, and/or does not transmit or cancels transmission of the other uplink signals/channels, so as to reduce interference of other downlink signals/channels and/or other uplink signals/channels on reception of DL PRS, and reduce latency of the positioning measurement process;
Optionally, when capability or type of PPW is 1A and/or 1B and/or 2, executing UE behaviours of receiving the DL PRS and/or receiving and/or not receiving the other downlink signals/channels and/or transmitting and/or not transmitting the other uplink signals/channels;
When a capability or type of the PPW is 1A, if the DL PRS is determined to be higher priority than other downlink signals/channels inside the PPW, those other downlink signals/channels are not expected to be measured by the UE. When the capability or type of the PPW is 1B, if the DL PRS is determined to be higher priority than other downlink signals/channels inside the PPW, those other downlink signals/channels in a same band as the DL PRS are not expected to be measured by the UE. When the capability or type of the PPW is 2, if the DL PRS is determined to be higher priority than other downlink signals/channels inside the PPW, those other downlink signals/channels from the impacted serving cells are not expected to be measured by the UE on overlapped symbols with the DL PRS, where impacted serving cells refer to the serving cell on which the PRSProcessing Window parameter is configured for a frequency range 1 band; and with respect to a frequency range 2 band, the impacted serving cells refer to all the serving cells in the same band as the DL PRS; The first threshold value N1 and/or the second threshold value N2 may be a parameter value reported by the user equipment UE according to its own processing capability and/or a parameter value configured by the base station that is received by the UE and/or a pre-configured parameter value;
The X may be a parameter value reported by the user equipment UE according to its own processing capability and/or a parameter value configured by a base station that is received by the UE and/or a preconfigured parameter value. Optionally, X may be a value greater than or equal to (or not less than) the first threshold value N1. Optionally, X may be determined according to the DCI decoding time and/or the MAC CE activation time and/or the BWP switching time and/or start point offset time of transmission of other downlink signals/channels, for example, X may be equal to “T+s1+S+M”, where, T is a time unit from receiving the DCI indication information to completing decoding of the indication information (i.e., the DCI decoding time), s1 is the BWP switching time, where, s1 may be a real number greater than or equal to 0, S is start point offset time of transmission of other downlink signals/channels, M is a time length from receiving the MAC CE activation indication to the closest first PPW start time (to which this activation indication is applied), for example, M=3*Nₛₗₒₜ^{subframe,μ} slots, where, Nₛₗₒₜ^{subframe,μ} denotes the number of slots included in each subframe when subcarrier spacing configuration is u, and a value of u may be {0, 1, 2, 3, 4}. It should be understood that, the above-described formula for determining X is only exemplary, and other parameters may also be used or modification to the formula is possible so as to determine X without departing from the scope of the present disclosure. For example, if UE determines that it is expected to receive the other downlink signals/channels scheduled by DCI no later than X time units before the starting position of the PPW, since the starting position of the PPW is determined after the UE determines that it is expected to receive the other downlink signals/channels scheduled by the DCI, the UE cannot judge, when receiving other downlink signals/channels, whether the other downlink signals/channels are within the activated PPW, even when capability or type of the PPW is specified as 1A and/or 1B and/or 2, the UE is expected to prioritize the reception of the DL PRS, and/or the UE may receive the other downlink signals/channels according to the UE capability. According to an embodiment of the present disclosure, an exemplary reception timeline of a DL signal within the activated first PPW is shown in FIG. 4; in FIG. 4, the entire block may represent the activated first PPW; before X time units before the starting position of the first PPW, the UE receives and completes decoding of the DCI for scheduling the PDSCH, so that the time domain position of the PDSCH scheduled by the DCI may be determined. Therefore, on the premise of not affecting reception of DL PRS, the UE may determine to receive the PDSCH according to its own capability, thereby increasing spectral efficiency; those skilled in the art should understand that, the PDSCH shown in FIG. 4 is only an example of a downlink signal, and may be replaced with PDCCH or other uplink signals/channels; a positional relationship between PDSCH and the first PPW is only exemplary, and other positional relationships are also considered within the scope of the present disclosure;
Optionally, the starting position of the DL PRS may be a starting position of a first DL PRS and/or a starting position of any DL PRS within the PPW;
Optionally, the PPW may be an activated PPW and/or the first PPW activated after applying the activation indication;
When the high priority DL PRS collides with the PDCCH/PDSCH of msg2/msgB (and/or repeated transmissions of PDCCH/PDSCH) or when they meet the collision conditions, the UE receives the PDCCH/PDSCH of msg2/msgB (and/or repeated transmissions of PDCCH/PDSCH), and does not expect to receive or drop the high priority DL PRS to ensure integrity of the random access procedure;
When high priority DL PRS collides with search space of PDCCH and/or PDSCH (and/or repeated transmissions of PDCCH/PDSCH) of control resource set 0 CORESET0 of message 3 (msg3), and/or search space of the downlink physical downlink control channel (DL PDCCH) (and/or repeated transmissions of the DL PDCCH) of message 4 (msg4), and/or the on-going random access procedure related downlink signals/channels or when they meet the collision conditions, the UE receives the search space of PDCCH and/or PDSCH (and/or repeated transmissions of PDCCH/PDSCH) of control resource set 0 CORESET0 of message 3 (msg3), and/or search space of the downlink physical downlink control channel (DL PDCCH) (and/or repeated transmissions of the DL PDCCH) of message 4 (msg4), and/or the on-going random access procedure related downlink signals/channels, and does not expect to receive or drops high priority DL PRS to ensure integrity of the random access procedure;
When the high priority DL PRS collides with the Low Priority (LP) PUCCH/PUSCH and/or SRS or when they meet the collision conditions, the UE is expected to receive the DL PRS, does not transmit or drops the LP PUCCH/PUSCH and/or SRS, so as to reduce interference of other uplink signals/channels on reception of DL PRS, and reduce latency of the positioning measurement procedure;
When the high priority DL PRS collides with the High Priority (HP) PUCCH/PUSCH and/or RACH related signals/channels (e.g., PRACH, PUCCH/PUSCH (and/or repeated transmissions of PUCCH/PUSCH) of msg1, msg3, msg4/B) or when they meet the collision conditions, the UE is expected to transmit the HP PUCCH/PUSCH and/or the RACH related signals/channels, do not receive or drop the DL PRS, so as to ensure integrity of the random access procedure.
Optionally, in the case that capability or type of PPW is 1A and/or 1B and/or 2, if the high priority DL PRS collides with other downlink signals/channels and/or other uplink signals/channels or if they meet collision conditions, the behaviours of the UE may include a combination of one or more of items below:
   The UE does not expect to receive high priority DL PRS within the PPW, to ensure the high priority characteristics of other downlink signals/channels and/or other uplink signals/channels which are more important;
   The UE does not expect to receive other downlink signals/channels and/or transmit resources of the other uplink signals/channels or transmit other uplink signals/channels within the PPW, so as to ensure a low-latency positioning procedure;
   The UE is not expected to receive the high priority DL PRS on symbols that collide in the time domain within the PPW, and is expected to receive the high priority DL PRS on symbols that do not collide in the time domain within the PPW, so as to reduce latency of the positioning procedure;
   The UE is not expected to receive other downlink signals/channels and/or transmit resources of the other uplink signals/channels or transmit other uplink signals/channels on the symbols that collide in the time domain within the PPW, and is expected to receive other downlink signals/channels and/or transmit other uplink signals/channels on the symbols that do not collide in the time domain within the PPW; and such operation may reduce reception latency of other downlink signals/channels and/or transmission latency of other uplink signals/channels without affecting reception of the DL PRS, and increase spectral efficiency.
Optionally, the other downlink signals/channels may be semi-persistently scheduled other downlink signals/channels and/or dynamically scheduled other downlink signals/channels;
Optionally, the base station may be a sidelink device;
The transmitting resources of other uplink signals/channels may include transmitting other uplink signals/channels on the time unit and/or frequency unit where other uplink signals/channels are located; and the preparing for transmission of other uplink signals/channels may include transmitting other uplink signals/channels by using a timing advance method.

Considering that Hybrid automatic repeat request Acknowledgement (HARQ-ACK) and/or Negative Acknowledgement (NACK) and/or PUCCH (and/or repeated transmissions of PUCCH) of RACH msg3/msgB/msg4 is more important, when the DL PRS collides with HARQ-ACK and/or NACK signalling and/or the PUCCH (and/or repeated transmissions of PUCCH) of RACH msg3/msgB/msg4 or when they meets the collision conditions, the UE is expected to receive or transmit HARQ-ACK and/or NACK signalling and/or transmit PUCCH (and/or repeated transmissions of PUCCH) of RACH msg3/msgB/msg4, does not receive or drops the DL PRS.

If the DL PRS is determined to be of a low priority and/or if the UE is expected to receive other downlink signals/channels and/or transmit the other uplink signals/channels, for example, the DL PRS is determined to be of a low priority based on a UE capability and/or an indication from the base station, then the behaviours of the UE may include a combination of one or more of items below:
If a time interval from a time unit and/or frequency unit for completing decoding of the scheduling indication information for the other downlink signals/channels, or receiving the scheduling indication information of the other downlink signals/channels, to the starting position of the DL PRS and/or the starting position of the PPW and/or the starting position of the DRX cycle is greater than or not less than the first threshold value N1, and/or if a time interval from a time unit and/or frequency unit for determining resources for transmitting the other uplink signals/channels or preparing for transmission of the other uplink signals/channels, to the starting position of the DL PRS and/or the starting position of the PPW and/or the starting position of the DRX cycle is greater than or not less than the second threshold value N2, then the UE does not expect to receive the DL PRS, and receives the other downlink signals/channels and/or transmits the other uplink signals/channels; if a time interval from a time unit and/or frequency unit for completing decoding of the scheduling indication information for the other downlink signals/channels, or receiving the scheduling indication information of the other downlink signals/channels, to the starting position of the DL PRS and/or the starting position of the PPW and/or the starting position of the DRX cycle is less than or not greater than the first threshold value N1, and/or if a time interval from a time unit and/or frequency unit for determining resources for transmitting the other uplink signals/channels or preparing for transmission of the other uplink signals/channels, to the starting position of the DL PRS and/or the starting position of the PPW and/or the starting position of the DRX cycle is less than or not greater than the second threshold value N2, then the UE is expected to receive the other downlink signals/channels and/or transmit the other uplink signals/channels in the PPW and/or the DRX cycle, and/or the UE may receive the DL PRS according to UE capability; and such operation may reduce reception latency of DL PRS without affecting reception of other downlink signals/channels and/or transmission of other uplink signals/channels so as to reduce latency of the positioning procedure, and increase spectral efficiency;
If UE determines the expected reception of other DL signals and channels or DCI/MAC CE scheduled/activated other DL signals/channels and/or the resource for the expected other UL signals/channels or the expected transmission of other UL signals/channels in the PPW and/or DRX cycle no later than the Y time units before the starting position of the DL PRS and/or the starting position of the PPW and/or the starting position of the DRX cycle, the UE is expected to receive the other DL signals/channels and/or transmit the other uplink signals/channels, and does not expect to receive the DL PRS; If UE determines the expected reception of other DL signals and channels or DCI/MAC CE scheduled/activated other DL signals/channels and/or the resource for the expected other UL signals/channels or the expected transmission of other UL signals/channels in the PPW and/or DRX cycle later than the Y time units before the starting position of the DL PRS and/or the starting position of the PPW and/or the starting position of the DRX cycle, the UE is expected to receive the other downlink signals/channels and/or transmit the other uplink signals/channels within the PPW and/or DRX cycle, and/or the UE may receive the DL PRS according to UE capability; and such operation may reduce reception latency of the DL PRS without affecting reception of other downlink signals/channels and/or transmission of other uplink signals/channels so as to reduce latency of the positioning procedure, and increase spectral efficiency;
If a time interval from a time unit and/or frequency unit that the UE determines to transmit resources of LP PUSCH/PUCCH and/or SRS or to prepare for transmission of the LP PUSCH/PUCCH and/or SRS within the PPW and/or DRX cycle to the starting position of the DL PRS and/or the starting position of the PPW and/or the starting position of the DRX cycle is greater than or not less than the third threshold value N3, then the UE does not expect to receive DL PRS and transmits LP PUSCH/PUCCH and/or SRS; if a time interval from a time unit and/or frequency unit that the UE determines to transmit resources of LP PUSCH/PUCCH and/or SRS or to prepare for transmission of LP PUSCH/PUCCH and/or SRS within the PPW and/or DRX cycle to the starting position of the DL PRS and/or the starting position of the PPW and/or the starting position of the DRX cycle is less than or not greater than the third threshold value N3, then the UE is expected to transmit the LP PUSCH/PUCCH and/or SRS within the PPW and/or DRX cycle, and/or the UE may receive DL PRS according to UE capability; and such operation may reduce reception latency of the DL PRS without affecting transmission of LP PUSCH/PUCCH and/or SRS, so as to reduce latency of the positioning procedure, and increase spectral efficiency;
If UE determines the expected transmission of LP PUSCH/PUCCH and/or SRS within the PPW and/or DRX cycle no later than the Y time units before the starting position of the DL PRS and/or the starting position of the PPW and/or the starting position of the DRX cycle, the UE does not expect to receive the DL PRS, and transmits LP PUSCH/PUCCH and/or SRS; If UE determines the expected transmission of LP PUSCH/PUCCH and/or SRS within the PPW and/or DRX cycle later than the Y time units before the starting position of the DL PRS and/or the starting position of the PPW and/or the starting position of the DRX cycle, the UE is expected to transmit the LP PUSCH/PUCCH and/or SRS within the PPW and/or DRX cycle, and/or the UE may receive the DL PRS according to the UE capability; and such operation may reduce reception latency of the DL PRS without affecting transmission of LP PUSCH/PUCCH and/or SRS, so as to reduce latency of the positioning procedure, and increase spectral efficiency;
If a time interval from a time unit and/or frequency unit that the UE determines to transmit resources of HP PUSCH/PUCCH and/or RACH related signals/channels (e.g. PRACH, PUCCH/PUSCH (and/or repeated transmissions of PUCCH/PUSCH) of msg1, msg3, msg4/B) or to prepare for transmission thereof within the PPW and/or DRX cycle to the starting position of the DL PRS and/or the starting position of the PPW and/or the starting position of the DRX cycle is greater than or not less than the third threshold value N3, then the UE does not expect to receive the DL PRS and transmits HP PUSCH/PUCCH and/or RACH related signals/channels; if a time interval from a time unit and/or frequency unit that the UE determines to transmit resources of HP PUSCH/PUCCH and/or RACH related signals/channels (e.g. PRACH, PUCCH/PUSCH (and/or repeated transmissions of PUCCH/PUSCH) of msg1, msg3, msg4/B) or to prepare for transmission thereof within the PPW and/or DRX cycle to the starting position of the DL PRS and/or the starting position of the PPW and/or the starting position of the DRX cycle is less than or not greater than the third threshold value N3, then the UE is expected to transmit the HP PUSCH/PUCCH and/or RACH related signals/channels within the PPW and/or DRX cycle, and/or the UE may receive the DL PRS according to UE capability; and such operation may reduce reception latency of the DL PRS without affecting transmission of HP PUSCH/PUCCH and/or RACH related signals/channels, so as to reduce latency of the positioning procedure, and increase spectral efficiency;
If UE determines the expected transmission of HP PUSCH/PUCCH and/or RACH related signals/channels (e.g. PRACH, PUCCH/PUSCH (and/or repeated transmissions of PUCCH/PUSCH) of msg1, msg3, msg4/B) within the PPW and/or DRX cycle no later than the Y time units before the starting position of the DL PRS and/or the starting position of the PPW and/or the starting position of the DRX cycle, the UE is not expected to receive the DL PRS, and transmits HP PUSCH/PUCCH and/or RACH related signals/channels; If UE determines the expected transmission of HP PUSCH/PUCCH and/or RACH related signals/channels (e.g. PRACH, PUCCH/PUSCH (and/or repeated transmissions of PUCCH/PUSCH) of msg1, msg3, msg4/B) within the PPW and/or DRX cycle later than the Y time units before the starting position of the DL PRS and/or the starting position of the PPW and/or the starting position of the DRX cycle, the UE is expected to transmit the HP PUSCH/PUCCH and/or RACH related signals/channels within the PPW and/or DRX cycle, and/or the UE may receive the DL PRS according to UE capability; and such operation may reduce reception latency of DL PRS without affecting transmission of HP PUSCH/PUCCH and/or RACH related signals/channels, so as to reduce latency of the positioning procedure, and increase spectral efficiency;
When the low priority DL PRS collides with the low priority (LP) PUCCH and/or PUSCH and/or SRS or when they meet the collision conditions, the UE is expected to receive the DL PRS and do not transmit the low priority PUCCH and/or PUSCH and/or SRS; such a mode can implement a low-latency positioning procedure, and the PRS is considered to be more important than the PUCCH and/or PUSCH and/or SRS of a same priority within the PPW;
Optionally, the starting position of the DL PRS may be a starting position of a first DL PRS and/or a starting position of any DL PRS within the PPW;
The first threshold value N1 and/or the second threshold value N2 and/or the third threshold value N3 may be a parameter value reported by the user equipment UE according to its own processing capability and/or a parameter value configured by a base station that is received by the UE and/or a preconfigured parameter value;
The Y may be a parameter value reported by the user equipment UE according to its own processing capability and/or a parameter value configured by a base station that is received by the UE and/or a preconfigured parameter value. Optionally, Y is a value greater than or equal to (or not less than) the first threshold value N1.
Optionally, the PPW may be an activated PPW and/or a first PPW activated after applying an activation indication, and the DRX cycle may include a combination of one or more of items below:
   A DRX cycle for monitoring (DCI-scheduled) paging and/or executing PRS mea-surements;
   A DRX cycle within a Paging Occasion (PO) and/or a DRX cycle overlapping with the paging occasion, when the UE is activated by a Paging Early Indication (PEI) to monitor one and/or P Paging Occasions (POs);
   a DRX cycle corresponding to paging occasions and/or current and/or next P paging cycles indicated by paging occasion related signals, and/or a paging cycle for PRS measurement;
   A DRX cycle that is awakened when trigger information (e.g., DCI and/or MAC CE) is received within a paging occasion, for example, the trigger information is used to trigger monitoring of paging messages and/or executing PRS measurement in the DRX cycle;
   P may be a parameter value reported by the user equipment UE according to its own processing capability and/or a parameter value configured by the base station that is received by the UE and/or a preconfigured parameter value.
Optionally, in the case that capability or type of PPW is 1A and/or 1B and/or 2, if the low priority DL PRS collides with other downlink signals/channels and/or other uplink signals/channels or if they meet the collision conditions, then the UE is not expected to receive low priority DL PRS within the PPW, and is expected to receive other downlink signals/channels and/or transmit other uplink signals/channels, and/or the UE is not expected to receive low priority DL PRS on symbols that collide in the time domain within the PPW, and it is expected to receive low priority DL PRS on symbols that do not collide in the time domain within the PPW;
Optionally, the base station may be a sidelink device;
The transmitting resources of other uplink signals/channels may include transmitting other uplink signals/channels on the time unit and/or frequency unit where other uplink signals/channels are located; and the preparing for transmission of other uplink signals/channels may include transmitting other uplink signals/channels by using a timing advance method.

When the DL PRS collides with the SSB or when they meet the collision conditions, or when the DL PRS does not collide with the SSB or when they do not meet the collision conditions, the behaviours of the UE may include a combination of one or more of items below:
If UE determines the expected reception of SSB in the PPW and/or DRX cycle no later than the Y time units before the starting position of the DL PRS and/or the starting position of the PPW and/or the starting position of the DRX cycle, then according to whether the UE supports a capability of parallel processing of DL PRS and Radio Resource Management (RRM) measurement (SSB measurement may be executed in RRM measurement) and/or demands, it is decided by the UE to receive DL PRS and/or SSB; those skilled in the art should understand that, in the present disclosure, the expression “decided by the UE” may include a meaning of “determined by the UE”, or may also include a meaning of “an action of decision and/or determination made by the UE according to its own actual situation;
If a time interval from a time unit and/or frequency unit that the UE determines to receive SSB within the PPW and/or DRX cycle to the starting position of the DL PRS and/or the starting position of the PPW and/or the starting position of the DRX cycle is greater than or not less than a fifth threshold value N5, then according to whether the UE supports a capability of parallel processing of DL PRS and RRM measurement and/or demands, it is decided by the UE to receive the DL PRS and/or SSB, wherein, the fifth threshold value N5 may be a parameter value reported by the user equipment UE according to its own processing capability and/or a parameter value configured by the base station that is received by the UE and/or a preconfigured parameter value;
When the DL PRS collides with the SSB or when they meet the collision conditions, if the UE supports parallel processing of the DL PRS and radio resource management RRM measurement, then, it is decided by the UE to receive the DL PRS and/or SSB; if the UE does not support parallel processing of DL PRS and radio resource management RRM measurement, according to the determined priority states of the DL PRS and the other downlink signals/channels (non-SSB), when the DL PRS is determined to be higher priority than the other downlink signals/channels (non-SSB), the UE is expected to receive the DL PRS; when the DL PRS is determined to be lower priority than the PDCCH and PDSCH of Ultra-reliable and Low Latency Communications (URLLC), and higher priority than the other downlink signals/channels, the UE is expected to receive the DL PRS; and when the DL PRS is determined to be lower priority than the other downlink signals/channels (non-SSB), the UE is expected to receive SSB;
When capability or type of PPW is 1A and/or 1B and/or 2, if the UE determines to receive SSB, the UE does not expect to receive DL PRS within the PPW and/or on overlapping time units and/or frequency units.

According to some implementations, in conjunction with some aspects of the present disclosure, a calculation mode of the Carrier-Specific Scaling Factor (CSSF) may include a combination of one or more of items below:
If the DL PRS is determined to be of a high priority (according to a UE capability and/or an indication from the base station) and/or UE determines to receive the DL PRS, then CSSF=1;
If the DL PRS is determined to be of a low priority (according to a UE capability and/or an indication from the base station) and/or the UE determines to receive the SSB, then the CSSF is calculated according to calculation modes of Stand Alone operation mode (SA mode) and/or NR-NR Dual Connectivity mode (NR-DC mode) and/or NR Evolved universal terrestrial radio access Dual Connectivity mode (NE-DC mode) in out-of-interval multi-layer monitoring or in-interval multi-layer monitoring.

When the PPW is activated and/or the priority of the PRS is higher than priorities of other downlink signals/channels and/or other uplink signals/channels, with respect to the impacted symbols within the PPW, the behaviours of the MAC entity may be as follows:
If a ra-ResponseWindow or a ra-ContentionResolutionTimer or a msgB-Response Window is running, then receiving other downlink signals/channels and/or transmitting other uplink signals/channels, and optionally, monitoring the PDCCH, and/or receiving the downlink shared channel DL-SCH, and/or transmitting the uplink shared channel UL-SCH and/or PUCCH, and/or transmitting RACH related signals (e.g., Msg3 or MSGA payload); otherwise, not receiving other downlink signals/channels and/or not transmitting other uplink signals/channels, and optionally, not receiving DL-SCH, and/or not monitoring the PDCCH, and/or not transmitting UL-SCH and/or PUCCH, and/or not transmitting RACH related signals (e.g., Msg3 or MSGA payload).

When the PPW is activated and/or the priority of the PRS is lower than the priorities of other downlink signals/channels and/or other uplink signals/channels, with respect to the impacted symbols within the PPW, the behaviours of the MAC entity may include a combination of one or more of items below:
If a PRS reception notification from a lower layer is received, then not receiving other downlink signals/channels and/or not transmitting other uplink signals/channels, and optionally, not receiving the DL-SCH, and/or not receiving the PDCCH, and/or not transmitting UL-SCH and/or PUCCH, and/or not transmitting RACH related signals (e.g., Msg3 or MSGA payload);
If no PRS reception notification is received from the lower layer, then receiving other downlink signals/channels and/or transmitting other uplink signals/channels, and optionally, receiving DL-SCH, and/or receiving PDCCH, and/or transmitting UL-SCH and/or PUCCH, and/or transmitting RACH related signals (e.g., Msg3 or MSGA payload);
The PRS reception notification is a signalling transmitted from a lower layer (e.g., a physical layer) of the UE to a higher layer (e.g., a MAC layer) of the UE, to indicate reception of PRS.

If the DL PRS is determined to be of a low priority and/or when the UE is expected to receive other downlink signals/channels and/or transmit the other uplink signals/channels, for example, according to a UE capability and/or an indication from the base station, the DL PRS is determined to be of a low priority, the behaviours of the UE may include a combination of one or more of items below:
If a time interval from a time unit and/or frequency unit for completing decoding of the scheduling indication information for the other downlink signals/channels, or receiving the scheduling indication information of the other downlink signals/channels, to the starting position of the DL PRS and/or the starting position of the PPW and/or the starting position of the DRX cycle is less than or not greater than the first threshold value N1, and/or if a time interval from a time unit and/or frequency unit for determining resources for transmitting the other uplink signals/channels or preparing for transmission of the other uplink signals/channels, to the starting position of the DL PRS and/or the starting position of the PPW and/or the starting position of the DRX cycle is less than or not greater than the second threshold value N2, then UE determines or changes the priority of the current DL PRS to a high priority, that is, the UE is expected to receive the DL PRS and/or not receive the other downlink signals/channels and/or not transmit the other uplink signals/channels within the PPW and/or DRX cycle;
If UE determines the expected reception of other DL signals/channels or DCI/MAC CE scheduled/activated other DL signals/channels and/or the resource for the expected other UL signals/channels or the expected transmission of other UL signals/channels in the PPW and/or DRX cycle, later than the Y time units before the starting position of DL PRS and/or the starting position of the PPW and/or the starting position of the DRX cycle, the UE considers or changes the DL PRS as higher priority, that is, the UE expects to receive the DL PRS and/or not to receive the other downlink signals/channels and/or not to transmit the other uplink signals/channels within the PPW and/or DRX cycle;
If a time interval from a time unit and/or frequency unit that the UE determines to transmit resources of LP PUSCH/PUCCH and/or SRS or to prepare for transmission of LP PUSCH/PUCCH and/or SRS within the PPW and/or DRX cycle to the starting position of the DL PRS and/or the starting position of the PPW and/or the starting position of the DRX cycle is less than or not greater than the third threshold value N3, then the UE determines or changes the priority of the current DL PRS to a high priority, that is, the UE is expected to receive the DL PRS and/or not transmit LP PUSCH/PUCCH and/or SRS within PPW and/or DRX cycle;
If UE determines the expected transmission of LP PUSCH/PUCCH and/or SRS within the PPW and/or DRX cycle later than the Y time units before the starting position of the DL PRS and/or the starting position of the PPW and/or the starting position of the DRX cycle, the UE considers or changes the DL PRS as higher priority, that is, the UE expects to receive the DL PRS and/or not to transmit LP PUSCH/PUCCH and/or SRS within the PPW and/or DRX cycle;
When the low priority DL PRS collides with the Low Priority (LP) PUCCH and/or PUSCH and/or SRS or when they meet the collision conditions, the UE considers or changes the DL PRS as higher priority, that is, the UE expects to receive DL PRS, and not to transmit low priority PUCCH and/or PUSCH and/or SRS;
Optionally, the starting position of the DL PRS may be a starting position of a first DL PRS and/or a starting position of any DL PRS within the PPW;
The first threshold value N1 and/or the second threshold value N2 and/or the third threshold value N3 may be a parameter value reported by the user equipment UE according to its own processing capability and/or a parameter value configured by a base station that is received by the UE and/or a preconfigured parameter value;
The Y may be a parameter value reported by the user equipment UE according to its own processing capability and/or a parameter value configured by a base station that is received by the UE and/or a preconfigured parameter value. Optionally, Y is a value greater than or equal to (or not less than) the first threshold value N1.
Optionally, the PPW may be an activated PPW and/or a first PPW activated after applying an activation indication, and the DRX cycle may include a combination of one or more of items below:
   A DRX cycle for monitoring (DCI-scheduled) paging and/or executing PRS mea-surements;
   A DRX cycle within a Paging Occasion (PO) and/or a DRX cycle overlapping with the paging occasion, when the UE is activated by a Paging Early Indication (PEI) to monitor one and/or P Paging Occasions (POs);
   A DRX cycle corresponding to paging occasions and/or current and/or next P paging cycles indicated by paging occasion related signals and/or a paging cycle for PRS measurement;
   A DRX cycle that is awakened when trigger information (e.g., DCI and/or MAC CE) is received within a paging occasion, for example, the trigger information is used to trigger monitoring of paging messages and/or executing PRS measurement in the DRX cycle;
   P may be a parameter value reported by the user equipment UE according to its own processing capability and/or a parameter value configured by the base station that is received by the UE and/or a preconfigured parameter value.
Optionally, in the case that capability or type of PPW is 1A and/or 1B and/or 2, if the low priority DL PRS collides with other downlink signals/channels and/or other uplink signals/channels or if they meet the collision conditions, then the UE is not expected to receive low priority DL PRS within the PPW, and is expected to receive other downlink signals/channels and/or transmit other uplink signals/channels, and/or the UE is not expected to receive low priority DL PRS on symbols that collide in the time domain within the PPW, and is expected to receive low priority DL PRS on symbols that do not collide in the time domain within the PPW;
Optionally, the base station may be a sidelink device;
The transmitting resources of other uplink signals/channels may include transmitting other uplink signals/channels on the time unit and/or frequency unit where other uplink signals/channels are located; and the preparing for transmission of other uplink signals/channels may include transmitting other uplink signals/channels by using a timing advance method;
Considering that hybrid automatic repeat request acknowledgement HARQ-ACK and/or negative acknowledgement NACK and/or PUCCH (and/or repeated transmissions of PUCCH) of RACH msg3/msgB/msg4 (also referred to as random access procedure related signals/channels in the present application) is more important, when the low priority DL PRS collides with HARQ-ACK and/or NACK signalling and/or the PUCCH (and/or repeated transmissions of PUCCH) of RACH msg3/msgB/msg4 or when they meet the collision conditions, the UE is expected to receive or transmit HARQ-ACK and/or NACK signalling and/or transmit PUCCH (and/or repeated transmissions of PUCCH) of RACH msg3/msgB/msg4, not receive or drop the DL PRS. Therefore, when other downlink signals/channels and/or other uplink signals/channels are ACKs/NACKs or random access procedure related signals/channels, the UE may not change or change the priority of the DL PRS, and not receive or drop the DL PRS;
The content as described above may be referred to for the conditions for determining whether the DL PRS collides with other downlink signals/channels and/or other uplink signals/channels.

The UE may determine a priority relationship between the DL PRS and a first downlink signals/channels as indicated by a high-layer signaling “DL-PPW-PreConfig DL-PPW-PreConfig”; when the UE reports a variety of PRS processing window types, if the priority option of DL PRS and the first downlink signals/channels corresponding to the reported PRS processing window type is option 3, then the UE determines the configured PRS processing window type as indicated by the high-layer signaling “DL-PPW-PreConfig”, and/or determines that the priority option of the DL PRS and the first downlink signals/channels as option 3 by a UE capability implicitly (by default), that is, the DL PRS priority is higher than that of the first downlink signals/channels; when the UE reports a PRS processing window type, if the priority option of the DL PRS and the first downlink signals/channels corresponding to the reported PRS processing window type is option 1 or option 2, or if the corresponding priority option of DL PRS and the first downlink signals/channels is not option 3, then the UE determines the priority state of the DL PRS as indicated by the high-layer signaling “DL-PPW-PreConfig”; when the UE reports a PRS processing window type, if the priority option of the DL PRS and the first downlink signals/channels corresponding to the reported PRS processing window type is option 3, then the UE determines that the priority option of the DL PRS and the first downlink signals/channels is option 3 through the UE capability implicitly (by default), that is, the priority of the DL PRS is higher than that of the first downlink signals/channels;

When the UE reports a variety of PRS processing window types, the UE determines the configured PRS processing window type as indicated by the high-layer signaling “DL-PPW-PreConfig”; when the UE reports a PRS processing window type, the UE determines the PRS processing window type as implied by UE capability (by default). PRS processing window types are in one-to-one correspondence with priority options; that is, each PRS processing window type has a unique corresponding priority option; after the PRS processing window type and/or the priority option of the corresponding DL PRS and the first downlink signals/channels is determined, if the priority option of the DL PRS and the first downlink signals/channels corresponding to the PRS processing window type determined by the UE is option 1 or option 2, or if the corresponding priority option of the DL PRS and the first downlink signals/channels is not option 3, then the UE determines the priority state of the DL PRS as indicated by the high-layer signaling “DL-PPW-PreConfig”; if the priority option of the DL PRS and the first downlink signals/channels corresponding to the PRS processing window type determined by the UE is option 3, then the UE determines that the priority option of the DL PRS and the first downlink signals/channels is option 3 as implied by UE capability (by default), that is, the DL PRS priority is higher than that of the first downlink signals/channels;

For receiving the DL PRS outside the measurement window and within the PRS processing window, the UE determines the configured PRS processing window with type 1A or 1B or 2 as indicated by the high-layer signaling “DL-PPW-PreConfig” or as implied by UE capability (by default), and if the corresponding PRS priority option is not option 3 (or is option 1 or 2), then the UE determines the PRS priority state as indicated by the high-layer signaling “DL-PPW-PreConfig”; otherwise, the UE determines the PRS priority state as implied by UE capability (by default), that is, the UE determines that the PRS priority state is state 1 in the PRS priority option 3, and the PRS priority is higher than that of the first downlink signals/channels. The priority relationship between the DL PRS and the first downlink signals/channels may be divided into 3 different priority options, namely, options 1/2/3; with respect to option 1, the priority relationship between the DL PRS and the first downlink signals/channels may be divided into 2 priority states, state 1 indicates that the DL PRS priority is higher than the first downlink signals/channels; state 2 indicates that the PRS priority is lower than the first downlink signals/channels. With respect to option 2, the priority relationship between the DL PRS and the first downlink signals/channels may be divided into three priority states; state 1 indicates that the DL PRS priority is higher than the first downlink signals/channels; state 2 indicates that the DL PRS priority is lower than PDCCH and URLLC PDSCH, and higher than the first downlink signals/channels (i.e., non-DL PRS, non-PDCCH, non-URLLC PDSCH, non-URLLC signals or channels), wherein, the URLLC PDSCH channel at least corresponds a dynamically scheduled PDSCH whose PUCCH resource for carrying ACK/NAK is marked as high-priority; and state 3 indicates that the DL PRS priority is lower than the first downlink signals/channels. With respect to option 3, the priority relationship between the DL PRS and the first downlink signals/channels has only 1 priority state, and state 1 indicates that the DL PRS priority is higher than the first downlink signals/channels.

The UE may determine the priority relationship between the DL PRS and the SSB according to a pre-given or pre-configured or fixed manner. The SSB may be a first SSB and/or a second SSB; the first SSB refers to an SSB that is not (expected) to be measured and/or an SSB that is located outside the SSB measurement timing configuration (SSB-MeasurementTimingConfiguration); the second SSB refers to an SSB that is (expected) to be measured and/or an SSB that is located within the SSB measurement timing configuration (SSB-MeasurementTimingConfiguration);

When the DL PRS measurement is performed within the PRS processing window outside the measurement window, the UE determines that the PRS has a higher priority than an SSB that is not measured in the SMTC, that is, the first SSB. For example, the priority relationship between the DL PRS and the SSB may be divided into 2 priority states. The DL PRS priority is higher than the first SSB, that is, the first SSB is determined as a low priority, and a DL PRS that collides with the first SSB is determined as a high priority. When the UE determines that the DL PRS priority is higher than the first SSB, the UE is expected to measure the DL PRS. The DL PRS priority is lower than the second SSB, that is, the second SSB is determined as a high priority, and the DL PRS that collides with the second SSB is determined as a low priority. When the UE determines that the DL PRS priority is lower than the second SSB, the UE is not expected to measure the DL PRS and/or is expected to receive the second SSB.

When the UE has an activated PRS processing window with type 1A or 1B and the UE determines the presence of other DL signals/channels including the second SSB, of higher priority than the DL PRS in the PRS processing window no later than Y time units before the first symbol of the PRS processing window, the UE is expected to receive the other DL signals and channels including the second SSB and drop all PRS within the PRS processing window. When the UE has an activated PRS processing window with type 2 and the UE determines the presence of other DL signals and channels including the second SSB, of higher priority than the DL PRS on a symbol configured with the DL PRS no later than Y time units before the DL PRS symbol, the UE is expected to receive the other DL signals and channels including the second SSB and drop the DL PRS symbol.,

When the UE has an activated PRS processing window with type 1A or 1B and the UE determines the presence of other DL signals/channels including the second SSB, of higher priority than the DL PRS in the PRS processing window later than Y time units before the first symbol of the PRS processing window, the UE is not required to receive the second SSB and/or may receive the DL PRS, and/or consider the DL PRS as higher priority in the PRS processing window. When the UE has an activated PRS processing window with type 2 and the UE determines the presence of other DL signals and channels including the second SSB, of higher priority than the DL PRS on a symbol configured with the DL PRS later than Y time units before the DL PRS symbol, the UE is not required to receive the other DL signals and channels including the second SSB, and/or may receive the DL PRS symbol, and/or consider the DL PRS as higher priority in that symbol.

Those skilled in the art should understand that, in the above-described embodiment in which the priority of the current DL PRS is determined or changed to a high priority, a subsequent behaviour of the UE may be any behaviour of UE, and is not limited to the behaviour of the UE as described in the present disclosure. Those skilled in the art should also understand that, contents of aspects such as other downlink signals/channels, other uplink signals/channels, and methods for determining the priorities of reference signal for positioning and other uplink signals/channels described in conjunction with the embodiments of the present disclosure, etc. may be used in combination with the above-described embodiment in which the priority of the current DL PRS is determined or changed to a high priority, or may not be used in combination with the above-described embodiment in which the priority of the current DL PRS is determined or changed to a high priority, without departing from the scope of the present disclosure. That is, various aspects described according to various embodiments of the present disclosure may be used alone or in any combination without departing from the scope of the present disclosure.

Those skilled in the art should understand that, description of “determine . . . expect . . . ” and “determines it is expected to” appearing in the present disclosure may include a meaning of “determining”, or may also include a meaning of “expecting”, or may also include meanings of “determining” and “expecting” at the same time.

“User equipment” or “UE” herein may refer to any terminal having wireless communication capabilities, including but not limited to a mobile phone, a cellular phone, a smart phone or a Personal Digital Assistant (PDA), a portable computer, an image capture device such as a digital camera, a gaming device, a music storage and playback device, and any portable unit or terminal having wireless communication capabilities, or an Internet facility that allows wireless Internet access and browsing, etc.

The term “base station” (BS) or “network device” as used herein may refer to an eNB, an eNodeB, a NodeB or a base transceiver station (BTS) or a gNB, etc., depending on the technology and terminology used.

“Memory” herein may be of any type suitable for the technical environment herein, and may be implemented by using any suitable data memory technology, including but not limited to a semiconductor-based memory device, a magnetic memory device and system, an optical memory device and system, a fixed memory and a removable memory.

The processor herein may be of any type suitable for the technical environment herein, including but not limited to one or more of: a general purpose computer, a special purpose computer, a microprocessor, a Digital Signal Processor (DSP), and a processor based on a multi-core processor architecture.

The above merely are preferred embodiments of the present disclosure, and are not intended to limit the present disclosure. Any modification, equivalent substitution, improvement, and the like, made within the spirit and principles of the present disclosure should be covered within the protection scope of the present disclosure.

Those skilled in the art may understand that, the present disclosure includes devices for executing one or more of the operations in the present disclosure. These devices may be specially designed and fabricated for required purposes, or may also include those known devices in general purpose computers. These devices have computer programs stored therein; and these computer programs are selectively activated or re-configured. Such a computer program may be stored in a device (e.g., a computer) readable medium or stored in any type of medium suitable for storing electronic instructions and respectively coupled to a bus; the computer readable medium includes, but is not limited to, any type of disk (including a floppy disk, a hard disk, an optical disk, a CD-ROM, and a magneto-optical disk), a Read-Only Memory (ROM), a Random Access Memory (RAM), an Erasable Programmable Read-Only Memory (EPROM), an Electrically Erasable Programmable Read-Only Memory (EEPROM), a flash memory, a magnetic card or an optical card. That is, a readable medium includes any medium that stores or transmits information in a form that may be read by a device (e.g., a computer).

Those skilled in the art may understand that, computer program instructions may be used to implement each block of these structural diagrams and/or block diagrams and/or flow diagrams, and combinations of blocks in these structural diagrams and/or block diagrams and/or flow diagrams. Those skilled in the art may understand that, these computer program instructions may be provided to a general-purpose computer, a pro-fessional computer or a processor of other programmable data processing methods to implement, so that solutions specified in a block or a plurality of blocks of the structural diagrams and/or block diagrams and/or flow diagrams disclosed by the present disclosure may be executed by a computer or a processor of other programmable data processing method.

Those skilled in the art may recognize that, the present disclosure may be implemented in other specific forms without changing the technical idea or essential features of the present disclosure. Therefore, it should be understood that, the above-described embodiments are merely examples and are not limitative. The scope of the present disclosure is defined by the appended claims, rather than detailed description. Therefore, it should be understood that, all modifications or changes derived from the meaning and scope of the appended claims and equivalents thereof are within the scope of the present disclosure.

In the above-described embodiments of the present disclosure, all operations and steps may be selectively executed or may be omitted. Furthermore, operations and steps in each embodiment need not be executed sequentially, and the order of operations and steps may vary.

Although the present disclosure has been illustrated and described with reference to various embodiments of the present disclosure, those skilled in the art will understand that various changes can be made in form and detail without departing from the spirit and scope of the present disclosure as defined by the appended claims and equivalents thereof.

1. A method performed by a user equipment (UE) in wireless communication system, the method comprising:
determining a presence of a downlink (DL) signal or a DL channel of higher priority than a DL positioning reference signal (PRS) in a PRS processing window (PPW) no later than N symbols before a first symbol of the PPW;
based on the determination of the presence of the DL signal or the DL channel no later than the N symbols before the first symbol of the PPW, receiving the DL signal or the DL channel and dropping the DL PRS within the PPW;
determining the presence of the DL signal or the DL channel of higher priority than the DL PRS in the PPW later than the N symbols before the first symbol of the PPW; and
based on the determination of the presence of the DL signal or the DL channel later than the N symbols before the first symbol of the PPW, receiving the DL PRS.

2. The method of claim 1, wherein in case that the presence of the DL signal or the DL channel of higher priority than the DL PRS in the PPW is determined later than the N symbols before the first symbol of the PPW, the DL signal or the DL channel is not required to be received.

3. The method of claim 1, wherein in case that the presence of the DL signal or the DL channel of higher priority than the DL PRS in the PPW is determined later than the N symbols before the first symbol of the PPW, considering the DL PRS as higher priority.

4. The method of claim 1, wherein the N is a natural number.

5. The method of claim 1, wherein the DL PRS is determined to be a low priority.

6. The method of claim 1, further comprising:
receiving a physical downlink control channel (PDCCH),
wherein the DL channel is a physical downlink shared channel (PDSCH), and
wherein the PDSCH is scheduled by the PDCCH.

7. The method of claim 1, wherein the N is predetermined value.

8. A user equipment (UE) in wireless communication system, the UE comprising:
a transceiver; and
a controller configured to:
determine a presence of a downlink (DL) signal or a DL channel of higher priority than a DL positioning reference signal (PRS) in a PRS processing window (PPW) no later than N symbols before a first symbol of the PPW;
based on the determination of the presence of the DL signal or the DL channel no later than the N symbols before the first symbol of the PPW, receive the DL signal or the DL channel and dropping the DL PRS within the PPW;
determine the presence of the DL signal or the DL channel of higher priority than the DL PRS in the PPW later than the N symbols before the first symbol of the PPW; and
based on the determination of the presence of the DL signal or the DL channel later than the N symbols before the first symbol of the PPW, receive the DL PRS.

9. The UE of claim 8, wherein in case that the presence of the DL signal or the DL channel of higher priority than the DL PRS in the PPW is determined later than the N symbols before the first symbol of the PPW, the DL signal or the DL channel is not required to be received.

10. The UE of claim 8, wherein in case that the presence of the DL signal or the DL channel of higher priority than the DL PRS in the PPW is determined later than the N symbols before the first symbol of the PPW, considering the DL PRS as higher priority.

11. The UE of claim 8, wherein the N is a natural number.

12. The UE of claim 8, wherein the DL PRS is determined to be a low priority.

13. The UE of claim 8, wherein the controller is further configured to:
receive a physical downlink control channel (PDCCH),
wherein the DL channel is a physical downlink shared channel (PDSCH), and
wherein the PDSCH is scheduled by the PDCCH.

14. The UE of claim 8, wherein the N is predetermined value.
